(19) United States
(12) Patent Application Publication
(10) Pub. No.: US 2006/0120253 A1
(43) Pub. Date: Jun. 8, 2006

(54) Write-once optical recording mediums

(75) Inventors: Jung-Po Chen, Hsinchu (TW); Po-Fu Yen, Hsinchu (TW); Chih-Yuan Wu, Hsinchu (TW); Chih-Ming Lin, Hsinchu (TW); Tzuan-Ren Jeng, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/080,412

(22) Filed: Mar. 16, 2005

(30) Foreign Application Priority Data
Dec. 7, 2004 (TW) 93137788

(51) Int. Cl. G11B 7/24

(52) U.S. Cl. 369/272.1; 369/275.1

(57) ABSTRACT

A write-once optical recording medium includes an optical recording layer and a reaction layer attached to the optical recording layer, wherein the optical recording layer contains a phase change material and the reaction layer contains a dopant. Once the optical recording layer is first written in a predetermined manner, the dopant of the reaction layer diffuses into the phase change material of the optical recording layer, the resulting written optical recording layer is of amorphous phase and has a crystallization rate significantly lower than that of the un-written optical recording layer so that the written optical recording layer cannot be re-written. A light laser can be used to write the write-once optical recording medium of the present invention.

### FIELD OF THE INVENTION

The present invention relates to a write-once optical recording medium, and particularly to a write-once optical recording medium which uses an inorganic material as an optical recording layer.

### DESCRIPTION OF THE PRIOR ART

The use of a differential reflective index between a crystalline phase and an amorphous phase in an optical information storage medium was originated from Ovshinsky, et al. in 1970. Te alloys were the primary research subjects initially. The element Te is easy in forming an amorphous phase, but it has a crystallization temperature of only 11° C. and a rapid crystallization rate, which cause an unstable amorphous phase. In order to enhance the stability of the amorphous phase, other elements have been incorporated to form Te alloys. Dozens of alloy materials suitable for being used as an optical recording material have been made by researchers over the past 30 years. These materials include GeTe, GeTeS, SbSe, SbTe, BiTe, TeSeSbS, GeSnTe, TeSeGe, TeOInGeAu, SbSeBi, InSb+M, GaSbTe, TeSe+M, TeGeSbSe, GeSbTe, InSbTe, InSbSe, InTeSe, AgInTe, and AgInSbTe, etc. Up to now, however, only two major series of materials (GeSbTe and AgInSbTe) are phase change materials that are commercially feasible in the production of rewritable optical discs.

Furthermore, since the magnitude of the focal point of a laser light is proportional to the wavelength of the laser light, a recording density is inversely proportional to the wavelength of the laser light used. The CD series of optical discs adopt a near infrared (IR) light with a wavelength of 780 nm and have a capacity of 650 MB; and the DVD series of optical discs adopt an IR light with a wavelength of 635˜650 nm and have a capacity of 4.7 GB. As for the next generation HD-DVD series of optical discs having a capacity of over 15 GB, a blue laser light with a wavelength of about 400 nm will be used. Thus, the search for phase change materials suitable for a blue laser light has become a major task in the development for a HD-DVD rewritable optical disc. Since 1999, major manufacturers of optical discs from Japan and Europe have been publishing phase change materials suitable for a blue laser light in major international conferences. Most of these materials are GeSbTe stoichiometric compound series and doped Sb₆₉Te₃₁ eutectic alloy series derived from those commonly used in the current Cd and DVD discs. These materials include GeSbTe, GeSbSnTe, Ge+ doped eutectic Sb₆₉Te₃₁, AgInSbTe, Ge(Sb₆₉Te₃₁)+Sb and AgInSbTeGe, etc.

The existing researches on the inorganic materials for the next generation write-once optical disc are categorized as the following five groups:

(1) Deformation: formation of recesses in a substrate through heat absorption and heat release as well as outgas;

(2) Alloying of Bilayer: sputtering two adjoining recording layers and melting the layers, with laser heat, to form an alloy, wherein the reflectivity difference before and after the formation of the alloy is significant;

(3) Decomposition: sputtering a metal nitride and decomposing the metal nitride with laser heat, wherein the reflectivity difference before and after the decomposition is significant;

(4) Oxidization: sputtering a metal oxide mixture and making the metal oxide mixture form a stable stoichiometrical oxide with laser heat, wherein the reflectivity difference before and after the oxidization is significant;

(5) Phase change: sputtering an amorphous phase change material layer and transforming the layer, with laser heat, into a crystalline phase, wherein the reflectivity difference before and after the phase change is significant, wherein a high melting point or high crystallization rate material can be used to prevent a crystalline recording spot from becoming amorphous again. This writing mechanism is opposite to that, from crystalline phase to an amorphous recording spot, of the current phase change optical discs (e.g. DVD-RW).

### SUMMARY OF THE INVENTION

It is an object of the present invention to provide an inorganic write-once phase change optical recording medium.

It is another object of the present invention to provide a write-once optical recording medium which can be written with laser.

It is another object of the present invention to provide a write-once optical recording medium with a writing mechanism of recording spot phase change, by laser, from crystalline phase to amorphous.

It is a further object of the present invention to provide a write-once optical recording medium with a writing mechanism of recording spot phase change, by laser, from crystalline phase to amorphous as well as a high initialization rate.

In order to accomplish the above objects, a write-once optical recording medium constructed according to the present invention comprises an optical recording layer and a reaction layer attached to the optical recording layer, wherein the optical recording layer comprises a phase change material and the reaction layer comprises a dopant, and wherein the dopant of the reaction layer diffuses into the phase change material of the optical recording layer when the optical recording layer is first written in a predetermined manner, and the resulting written optical recording layer is of amorphous phase and has a crystallization rate lower than that of the un-written optical recording layer, so that the written optical recording layer can not be re-written.

Preferably, the dopant of the reaction layer is selected from the group consisting of Al, Ag, Ge, Au, Cu, Ti, Si, Ge—Te, Ge—Cr, Cu—Zn, Al—Ti, Ag—Ti, Al—Si and a mixture thereof. More preferably, the dopant of the reaction layer is selected from the group consisting of Ge, Ge—Te and Ga—Te. In one of the preferred embodiments of the present invention, the dopant of the reaction layer is Ge.

Preferably, the reaction layer has a thickness of 5-15 nm.

Preferably, the phase change material is an alloy selected from the group consisting of In—Ge—Sb—Te, Ge—Sn—Sb, Ga—Sb—In, Ge—Sb—Te and In—Ag—Sb—Te.

Preferably, the optical recording layer has a thickness of 5-25 nm.

Preferably, the optical recording medium of the present invention further comprises a substrate and a lower dielectric layer deposited on a surface of the substrate, wherein the optical recording layer is deposited on the lower dielectric layer and the reaction layer is deposited on the optical recording layer. More preferably, the optical recording medium of the present invention further comprises an upper dielectric layer deposited on the reaction layer and a reflection layer deposited on the upper dielectric layer. Optionally, an interface layer between the optical recording layer and the lower dielectric layer or an interface layer between the reaction layer and the upper dielectric layer is further provided.

Preferably, the optical recording medium of the present invention further comprises a substrate, a reflection layer deposited on a surface of the substrate and a lower dielectric layer deposited on the reflection layer; wherein the reaction layer is deposited on the lower dielectric layer and the optical recording layer is deposited on the reaction layer. More preferably, the optical recording medium of the present invention further comprises an upper dielectric layer deposited on the optical recording layer. Optionally, an interface layer between the reaction layer and the lower dielectric layer or an interface layer between the optical recording layer and the upper dielectric layer is further provided.

Preferably, the substrate has a thickness of 0.05 mm to 1.2 mm.

Preferably, the upper dielectric layer and the lower dielectric layer are independently a mixture of ZnS and SiO₂; or a nitride, oxide or oxy-nitride of Ge, GeCr, Al or Si.

Preferably, the reflection layer is selected from the group consisting of Ag, Al, Au, Cu and an alloy thereof.

Preferably, the interface layer is a nitride, oxide or oxy-nitride of Ge, GeCr, Al or Si.

### DETAILED DESCRIPTION OF THE INVENTION

The principle of the inorganic write-once phase change optical disc of the present invention is based on the addition of certain elements (such as Al, Ag, Ge, Au, Cu, Ti, Si, Ge—Te, Ga—Te, Ge—Cr, Cu—Zn, Al—Ti, Ag—Ti, Al—Si layer) into the phase change material to significantly decrease the crystallization rate. The writing mechanism in the present invention is the same as that, recording spot phase change from crystalline phase to amorphous, of the existing optical discs (e.g. DVD-RW), so that the initialization of the disc is essential before writing. A low-speed material may be used as an optical recording layer in a write-once optical disc because it cannot be erased at high speed; however, it still can be re-written at low speed, or be initialized at low speed and then re-written, so that the data is insecure. If a phase change material with a lower crystallization rate (in comparison with the low-speed material) is used, it may meet both the write-once and the data security requirements; however, the initialization rate will be much slower than that of the existing discs or even unable to be initialized. Therefore, the inventors of the present invention disclose an inorganic write-once phase change optical disc, which can satisfy the write-once, the data security and the high initialization rate requirements at the same time. We form a reaction layer (such as Al, Ag, Ge, Au, Cu, Ti, Si, Ge—Te, Ga—Te, Ge—Cr, Cu—Zn, Al—Ti, Ag—Ti, Al—Si thin film) between a high crystallization rate phase change recording layer and a dielectric layer. The reaction layer is mainly used to decrease the crystallization rate of a written spot of the recording layer. The crystallization rate of the recording layer is not decreased right after the coating, otherwise the initialization period will be prolonged or even the initialization of the recording layer cannot be completed. The working mechanism is making the temperature of the written spot of the recording layer higher than the melting point of the recording layer while it's written (the melting point of the phase change material of the recording layer used by the existing DVD-RW is about 500˜600° C.), which results in the melting of the phase change material of the written spot and the diffusion of the reaction material into the phase change material of the written spot at the same time, so that the phase change recording layer with a high crystallization rate is significantly decreased in the crystallization rate due to the addition of the reaction layer material while it's written. After the first writing in this manner, the written amorphous recording spot is unable to be erased, so that the requirements of write-once and data security can be satisfied. When the as-deposited films are initialized, the temperature of the recording layer is between its crystallization temperature and melting point (about 300° C.), the reaction layer doesn't melt at this temperature and no diffusion occurs, so that the as-deposited recording layer still can be crystallized quickly (high initialization rate) without degradation.

For the selection of the reaction layer material, the following must be taken into consideration: (1) the addition of the reaction layer material will cause the crystallization rate of the recording layer decreasing significantly; (2) when the recording layer is written, it can diffuse into the recording layer; (3) the reflectivity contrast ratio of the amorphous recording spot with the diffusion of the reaction layer material and the crystalline phase area of the recording layer cannot be lowered (the optical property must be adequate); (4) after it is added, the dissipation of the heat generated by writing the recording layer cannot be adversely affected, so that the size and the writing power of the recording spot are not affected (the thermal property must be adequate).

### EXAMPLE AND COMPARATIVE EXAMPLE

The write-once phase change optical disc of this example used In₅Ge₂(SbₓTe₁₋ₓ)₉₃ as the phase change material of a recording layer and Ge as a reaction layer in the fabrication of an optical disc (Disc A) having the following structure on a polycarbonate (PC): a lower dielectric layer/interface layer/recording layer/reaction layer/upper dielectric layer/reflection layer. The comparative example is a 4×DVD-RW (Disc B) prepared by the inventors, which has a film structure, excluding the reaction layer, is the same as that of the Disc A. The first to 10^{th} writing/erasing dynamic characteristics of the Disc A of the present invention and the comparative example Disc B were tested at 4× with a red-light laser and a dynamic tester.

The structure of Disc A was DVD-RW PC substrate (0.6 mm)\ZnSSiO₂ (70 nm)\GeN (5 nm)\InGeSbTe (15 nm)\Ge (5 nm)\GeN (15 nm)\Ag (150 nm)\adhesive (55 μm)\PC plate (0.6 mm). The structure of Disc B was DVD-RW PC substrate (0.6 mm)\ZnSSiO₂ (70 nm)\GeN (5 nm)\InGeSbTe (15 nm)\GeN (15 nm)\Ag (150 nm)\adhesive (55 μm)\PC plate (0.6 mm). The ZnSSiO₂, GeN, InGeSbTe, Ge and Ag layers were stacked on the DVD-RW PC substrate by vacuum sputtering with a DVD-RW sputter (MODULUS) commercially available from SINGULUS Ltd. The sputtering conditions were: for the preparation of the ZnSSiO₂ layer, a RF sputtering was used, a ZnS—SiO₂ target was used, the sputtering gas was hydrogen and the sputtering pressure was 2 mTorr; for the preparation of the GeN layer a Ge target reactive sputtering was used, the sputtering gas was argon and nitrogen (argon:nitrogen=1:3), and the sputtering pressure was 3 mTorr; for the preparation InGeSbTe a DC sputtering was used, which is the same as the phase change film of a 4×DVD-RW optical disc, a InGeSbTe target was used, the sputtering gas was argon, and the sputtering pressure was 2 mTorr; for the preparation of the Ge layer a DC sputtering was used, the sputtering gas was argon and the sputtering pressure was 2 mTorr; and for the preparation of the Ag layer a DC sputtering was used, the sputtering gas was argon and the sputtering pressure was 5 mTorr. After the sputtering, a PC plate of 0.6 mm in thickness was bound to the resulting structure with a UV hardening adhesive to obtain the optical discs.

After the fabrication of the optical discs, the Disc A and the Disc B were initialized by an initializer respectively (the rotation speed=14 m/s, the laser power=1000 mW), wherein the temperature of the phase change material of the as sputtered amorphous recording layer was raised to higher than it's crystallization temperature, thereby the as sputtered amorphous recording layer was transformed into crystalline phase. Next, we utilized an Expert DVD-RW tester to test, in a 4× writing/erasing manner, the first to 10^{th} writing/erasing dynamic characteristics of the Disc A and the Disc B under the following conditions: Pw=21 mW, Ttop=065 T, Tmp=0.5 T, Tcl=0 T and erasing power Pe=6.09 mW. The test results are listed in Tables 1 and 2.

TABLE 1
The test results of the Disc A of the present invention at 4× for
the first to 10^{th} writing/erasing (W1 to OW10) operations

| | W1 | OW2 | OW3 | OW5 | OW10 |
|---|---|---|---|---|---|
| WOCNRa (dB) | 36.5 | 35.5 | 35.2 | 35.1 | 34.9 |
| R14H (%) | 18.4 | 18.1 | 17.5 | 17.1 | 17 |
| dI14H | 0.097 | 0.116 | 0.160 | 0.147 | 0.113 |
| I3/I14 | 0.298 | 0.300 | 0.298 | 0.293 | 0.276 |
| I14/I14H | 0.650 | 0.663 | 0.658 | 0.665 | 0.673 |
| Asym | −0.001 | 0.065 | 0.095 | 0.115 | 0.154 |
| Beta | 0.016 | 0.088 | 0.130 | 0.152 | 0.201 |
| PIE Max | 37 | 1662 | 1662 | 1662 | 1662 |
| PIE Min | 4 | 1662 | 1662 | 1662 | 1662 |
| PIE Ave | 18.4 | 1662 | 1662 | 1662 | 1662 |
| PIF | 0 | 1662 | 1662 | 1662 | 1662 |
| Jitter % | 9.45 | 18.63 | 18.53 | 20.76 | 18.60 |

TABLE 2
The test results of the Disc B of the comparative example at 4× for
the first to 10th writing/erasing (W1 to OW10) operations

| | W1 | OW2 | OW3 | OW5 | OW10 |
|---|---|---|---|---|---|
| WOCNRa (dB) | 38.2 | 37.9 | 37.4 | 37.6 | 37.8 |
| R14H (%) | 22.8 | 22.7 | 22.6 | 22.8 | 22.9 |
| dI14H | 0.094 | 0.102 | 0.083 | 0.072 | 0.075 |
| I3/I14 | 0.300 | 0.290 | 0.296 | 0.288 | 0.287 |
| I14/I14H | 0.587 | 0.604 | 0.604 | 0.608 | 0.609 |
| Asym | −0.027 | −0.004 | 0.002 | 0.010 | 0.013 |
| Beta | −0.019 | 0.008 | 0.018 | 0.027 | 0.030 |
| PIE Max | 18 | 18 | 35 | 19 | 38 |
| PIE Min | 0 | 0 | 9 | 1 | 0 |
| PIE Ave | 8.1 | 6.1 | 21.8 | 7.1 | 6.1 |
| PIF | 0 | 0 | 0 | 0 | 27 |
| Jitter % | 8.35 | 7.90 | 8.58 | 7.83 | 7.97 |

The test items in Tables 1 and 2 are described as follows:

| Items | Description |
|---|---|
| WOCNRa | CNR of wobble |
| R14H (%) | Reflectivity of recorded disc |
| dI14H | Variation of I14H |
| I3/I14 | Modulated amplitude of HF signal |
| I14/I14H | Modulated amplitude of HF signal |
| Asym | HF signal asymmetry |
| Beta | β = (A1 + A2)/(A1 − A2) |
| | wherein (A1 − A2): is the difference between the peak |
| | levels A1 and A2 of HF signal |
| | (A1 + A2): is the peak-to-peak value of HF signal |
| PIE | PI errors in any consecutive 8 ECC blocks |
| PIF | PI Fail |
| Jitter (%) | Jitter of both edges of HF signal |

As it can be seen from Table 1 that, for the Disc A, the jitter for the first writing (W1) is 9.45% and the PIE average is 18.4. All of the jitters after the second writing are higher than 18.63% and all of the PIE averages are much higher than the specification value of 280. With the diffusion of the reaction layer, which is between the phase change recording layer and the upper dielectric layer, into the recording layer during the first writing, the crystallization rate of the amorphous recording spot is decreased and thus the requirement of write-once is met. As shown in the Table 2, the jitters of the Disc B from the first writing (W1) to the tenth (W10) are all less than 8.58%. Because the crystallization rate of the amorphous recording spot do not change significantly in comparison with the as-sputtered recording layer, the Disc B can be rewritten for a plurality of times.

Although the present invention has been explained in relation to its preferred embodiment, it is to be understood that many other possible modifications and variations can be made without departing from the spirit and scope of the invention as hereinafter claimed.

1. A write-once optical recording medium comprising an optical recording layer and a reaction layer attached to the optical recording layer, wherein the optical recording layer comprises a phase change material and the reaction layer comprises a dopant, and wherein the dopant of the reaction layer diffuses into the phase change material of the optical recording layer when the optical recording layer is first written in a predetermined manner, and the resulting written optical recording layer is of amorphous phase and has a crystallization rate lower than that of the un-written optical recording layer, so that the written optical recording layer can not be re-written.

2. The optical recording medium according to claim 1, wherein the dopant of the reaction layer is selected from the group consisting of Al, Ag, Ge, Au, Cu, Ti, Si, Ge—Te, Ge—Cr, Cu—Zn, Al—Ti, Ag—Ti, Al—Si and a mixture thereof.

3. The optical recording medium according to claim 2, wherein the dopant of the reaction layer is selected from the group consisting of Ge, Ge—Te and Ga—Te.

4. The optical recording medium according to claim 3, wherein the dopant of the reaction layer is Ge.

5. The optical recording medium according to claim 1, wherein the reaction layer has a thickness of 5-15 nm.

6. The optical recording medium according to claim 1, wherein the phase change material is an alloy selected from the group consisting of In—Ge—Sb—Te, Ge—Sn—Sb, Ga—Sb—In, Ge—Sb—Te and In—Ag—Sb—Te.

7. The optical recording medium according to claim 1, wherein the optical recording layer has a thickness of 5-25 nm.

8. The optical recording medium according to claim 1 further comprising a substrate and a lower dielectric layer deposited on a surface of the substrate, wherein the optical recording layer is deposited on the lower dielectric layer and the reaction layer is deposited on the optical recording layer.

9. The optical recording medium according to claim 8 further comprising an upper dielectric layer deposited on the reaction layer and a reflection layer deposited on the upper dielectric layer.

10. The optical recording medium according to claim 1 further comprising a substrate, a reflection layer deposited on a surface of the substrate and a lower dielectric layer deposited on the reflection layer; wherein the reaction layer is deposited on the lower dielectric layer and the optical recording layer is deposited on the reaction layer.

11. The optical recording medium according to claim 10 further comprising an upper dielectric layer deposited on the optical recording layer.

12. The optical recording medium according to claim 8 further comprising an interface layer between the optical recording layer and the lower dielectric layer.

13. The optical recording medium according to claim 8 further comprising an interface layer between the reaction layer and the upper dielectric layer.

14. The optical recording medium according to claim 10 further comprising an interface layer between the reaction layer and the lower dielectric layer.

15. The optical recording medium according to claim 11 further comprising an interface layer between the optical recording layer and the upper dielectric layer.

16. The optical recording medium according to claim 8, wherein the substrate has a thickness of 0.05 mm to 1.2 mm.

17. The optical recording medium according to claim 10, wherein the substrate has a thickness of 0.05 mm to 1.2 mm.

18. The optical recording medium according to any one of claim 8, wherein the lower dielectric layer is a mixture of ZnS and SiO₂; or a nitride, oxide or oxy-nitride of Ge, GeCr, Al or Si.

19. The optical recording medium according to any one of claim 9, wherein the upper dielectric layer is a mixture of ZnS and SiO₂; or a nitride, oxide or oxy-nitride of Ge, GeCr, Al or Si.

20. The optical recording medium according to any one of claim 10, wherein the lower dielectric layer is a mixture of ZnS and SiO₂; or a nitride, oxide or oxy-nitride of Ge, GeCr, Al or Si.

21. The optical recording medium according to any one of claim 11, wherein the upper dielectric layer is a mixture of ZnS and SiO₂; or a nitride, oxide or oxy-nitride of Ge, GeCr, Al or Si.

22. The optical recording medium according to claim 9, wherein the reflection layer is selected from the group consisting of Ag, Al, Au, Cu and an alloy thereof.

23. The optical recording medium according to claim 10, wherein the reflection layer is selected from the group consisting of Ag, Al, Au, Cu and an alloy thereof.

24. The optical recording medium according to claim 12, wherein the interface layer is a nitride, oxide or oxy-nitride of Ge, GeCr, Al or Si.

25. The optical recording medium according to claim 13, wherein the interface layer is a nitride, oxide or oxy-nitride of Ge, GeCr, Al or Si.

26. The optical recording medium according to claim 14, wherein the interface layer is a nitride, oxide or oxy-nitride of Ge, GeCr, Al or Si.

27. The optical recording medium according to claim 15, wherein the interface layer is a nitride, oxide or oxy-nitride of Ge, GeCr, Al or Si.
